(19) United States
(12) Patent Application Publication
(10) Pub. No.: US 2023/0409336 A1
(43) Pub. Date: Dec. 21, 2023

(54) VLIW Dynamic Communication

(71) Applicant: Advanced Micro Devices, Inc., Santa Clara, CA (US)

(72) Inventors: Sriseshan Srikanth, Austin, TX (US); Karthik Ramu Sangaiah, Seattle, WA (US); Anthony Thomas Gutierrez, Seattle, WA (US); Vedula Venkata Srikant Bharadwaj, Bellevue, WA (US); John Kalamatianos, Arlington, MA (US)

(73) Assignee: Advanced Micro Devices, Inc., Santa Clara, CA (US)

(21) Appl. No.: 17/843,640

(22) Filed: Jun. 17, 2022

(51) Int. Cl. G06F 9/38; G06F 9/32

(52) U.S. Cl. CPC G06F 9/3853; G06F 9/3885; G06F 9/321

(57) ABSTRACT

In accordance with described techniques for VLIW Dynamic Communication, an instruction that causes dynamic communication of data to at least one processing element of a very long instruction word (VLIW) machine is dispatched to a plurality of processing elements of the VLIW machine. A first count of data communications issued by the plurality of processing elements and a second count of data communications served by the plurality of processing elements are maintained. At least one additional instruction is determined for dispatch to the plurality of processing elements of the VLIW machine based on the first count and the second count. For example, an instruction that is independent of the instruction is determined for dispatch while the first count and the second count are unequal, and an instruction that is dependent on the instruction is determined for dispatch based on the first count and the second count being equal.

### BACKGROUND

Very long instruction word (VLIW) machines execute operations of VLIW instructions concurrently based on a fixed schedule, which is determined when a program is compiled. In contrast to other processor architectures, such as those in which each instruction encodes a single operation, VLIW machines execute VLIW instructions which each encode multiple operations. Doing so allows multiple operations to execute concurrently in order to provide improved utilization of processing power. VLIW machines can also be implemented with functionality to concurrently execute multiple encoded operations on a plurality of different data points, making such VLIW machines highly scalable. Because each VLIW instruction includes multiple operations, VLIW instructions are “very long” in comparison to the instruction word size utilized by conventional processors. VLIW machines are traditionally statically scheduled and thus require to schedule instructions and data movement operations under the assumption that operation latencies are either known or can be approximated statically. Due to their static nature, VLIW machines benefit from lower instruction issue logic overhead and complexity, as compared to conventional processors that utilize dynamic instruction scheduling.

### BRIEF DESCRIPTION OF THE DRAWINGS

The detailed description is described with reference to the accompanying figures.

FIG. 1 is a block diagram of a non-limiting example system having a compiler and a VLIW machine according to some implementations.

FIG. 2 depicts a non-limiting example in which a VLIW machine executes an instruction that includes dynamic communication fields populated with information for enabling dynamic communication.

FIG. 3 depicts a non-limiting example in which signals are communicated from a processing element array to an instruction controller according to some implementations.

FIG. 4 depicts a procedure in an example implementation of determining at least one additional instruction to dispatch to a plurality of processing elements based on a first count of data communications issued and a second count of data communications served.

FIG. 5 depicts a procedure in an example implementation of dispatching an independent instruction or a dependent instruction based on whether the first count is equal to the second count.

### DETAILED DESCRIPTION

Overview

Very long instruction word (VLIW) machines execute independent operations grouped in VLIW instructions concurrently based on a fixed schedule, which is determined when a program is compiled, e.g., prior to the VLIW instructions being executed. VLIW instructions that are scheduled when a program is compiled are referred to herein as “statically scheduled instructions.” In comparison, other processor architectures utilize dedicated hardware within the processor itself to identify independent operations and “dynamically identify” an order for instructions to execute while the processor is executing the program.

VLIW machines often include a plurality of processing elements, each capable of processing a VLIW instruction concurrently. Each VLIW instruction includes a number of operation fields populated with operations that can be executed concurrently by a respective processing element. In some implementations, the operations included in the operation fields of a VLIW instruction can be executed by a respective processing element at different pipe stages, and as such, the operations can be executed at least partially asynchronously by the respective processing element. VLIW instructions containing multiple fields populated with operations that are executable by VLIW machines are referred to herein as “instructions.” VLIW machines can also be configured to execute the operations encoded in a Single Instruction, Multiple Data (SIMD) instruction format. In accordance with SIMD processing, each processing element of a VLIW machine can execute the multiple encoded operations of a VLIW instruction concurrently, but each processing element of the VLIW machine executes the multiple encoded operations on different data.

Some classes of applications, such as graph analytics applications, can benefit from the implementation of VLIW-based SIMD processing. However, these classes of applications often include dynamic communication patterns that are incompatible with the static scheduling utilized by conventional VLIW machines. Notably, dynamic communication patterns involve data being dynamically communicated between processing elements and/or memory components of a processor in connection with processing an instruction. Dynamic communications of data are communications of variable latency, e.g., the time it takes to process the dynamic communication is not known when the program is compiled. Due to this, conventional VLIW machines encounter challenges when statically scheduling instructions that depend on a result of an instruction that causes dynamic communication.

To solve these problems, VLIW dynamic communication as described herein is leveraged. In one or more implementations, an instruction controller of the VLIW machine dispatches an instruction that causes data to be dynamically communicated from “source” processing elements to “destination” processing elements. The instructions contains both operation fields as well as additional information for enabling efficient dynamic communication among the processing elements of the VLIW machine. The format of this instruction contrasts with conventional VLIW instructions. In one or more implementations, the instruction includes a dynamic issue field that directs the source processing elements to issue data communications to the destination processing elements in connection with processing the instruction, and in response, transmit communication issued signals to the instruction controller. In one or more implementations, the instruction also includes a dynamic service field that directs the destination processing elements to accept the data communications from the source processing elements in connection with processing the instruction, and in response, transmit a communication served signal to the instruction controller.

In one or more implementations, the instruction controller maintains a first count of data communications issued by the plurality of processing elements based on the received communication issued signals. The instruction controller also maintains a second count of data communications served by the plurality of processing elements based on the received communication served signals. In accordance with the described techniques, the first count and the second count being unequal indicates to the instruction controller that the dynamic communication is ongoing, while the first count and the second count being equal indicates to the instruction controller that the dynamic communication is complete. In scenarios where the first count and the second count are unequal, the instruction controller can determine to dispatch an additional instruction that is independent of a result of processing the instruction. In contrast, when the first count and the second count are equal, the instruction controller determines to dispatch an additional instruction that is dependent on the result of processing the instruction.

By dispatching an independent instruction while the dynamic communication is ongoing, the VLIW machine is able to process the instruction without causing the VLIW machine to stall. Moreover, by dispatching a dependent instruction once the dynamic communication is complete, the instruction controller of the VLIW machine ensures correct execution of statically scheduled instructions that are dependent on the instruction that causes the dynamic communication. Furthermore, by dispatching the dependent instruction based on data communications actually issued and data communications actually received by the processing elements, the dependent instruction is dispatched based on the actual latency caused by the dynamic communication. Thus, as compared to conventional VLIW machines which stall while processing a dynamic communication and assume worst-case communication latencies, the described techniques lead to increased computational efficiency and performance.

In some aspects, the techniques described herein relate to a method comprising: dispatching, to a plurality of processing elements of a very long instruction word machine, an instruction that causes dynamic communication of data to at least one processing element of the very long instruction word machine; maintaining a first count of data communications issued by the plurality of processing elements and a second count of data communications served by the plurality of processing elements; and determining at least one additional instruction to dispatch to the plurality of processing elements of the very long instruction word machine based on the first count and the second count.

In some aspects, the techniques described herein relate to a method, wherein the at least one additional instruction is independent of the instruction and is dispatched while the first count and the second count are unequal.

In some aspects, the techniques described herein relate to a method, further comprising determining that the at least one additional instruction is independent of the instruction based on an instruction group field of the instruction and the at least one additional instruction indicating different instruction groups.

In some aspects, the techniques described herein relate to a method, wherein the at least one additional instruction is dependent on the instruction and is determined for dispatching based on the first count and the second count being equal.

In some aspects, the techniques described herein relate to a method, further comprising determining that the at least one additional instruction is dependent on the instruction based on an instruction group field of the instruction and the at least one additional instruction indicating a same instruction group.

In some aspects, the techniques described herein relate to a method, wherein at least one data communication is issued by one or more processing elements to provide data to the at least one processing element in connection with processing the instruction.

In some aspects, the techniques described herein relate to a method, further comprising incrementing the first count responsive to receiving a signal indicating that the one or more other processing elements issued the at least one data communication; and incrementing the second count responsive to receiving a signal indicating that the at least one processing element received the at least one data communication.

In some aspects, the techniques described herein relate to a method, further comprising: receiving a first aggregation of signals from one or more processing elements that provide data in connection with processing the instruction, the first count being based on the first aggregation of signals; and receiving a second aggregation of signals from one or more processing elements that obtain data in connection with processing the instruction, the second count being based on the second aggregation of signals.

In some aspects, the techniques described herein relate to a very long instruction word machine comprising: a plurality of processing elements; and an instruction controller to: dispatch, to the plurality of processing elements of the very long instruction word machine, an instruction that causes dynamic communication of data to at least one processing element of the very long instruction word machine; maintain a first count of data communications issued by the plurality of processing elements and a second count of data communications served by the plurality of processing elements; compare the first count and the second count; and determine at least one additional instruction to dispatch to the plurality of processing elements of the very long instruction word machine based on a comparison of the first count and the second count.

In some aspects, the techniques described herein relate to a very long instruction word machine, wherein the instruction includes a set of operations and each processing element of the plurality of processing elements is configured to perform the set of operations on different data.

In some aspects, the techniques described herein relate to a very long instruction word machine, wherein the one or more processing elements are configured to: issue at least one data communication to provide data to the at least one processing element in connection with processing the instruction; and transmit one or more signals indicating that the at least one data communication was issued by the one or more processing elements.

In some aspects, the techniques described herein relate to a very long instruction word machine, wherein the at least one processing element is configured to: receive the at least one data communication from the one or more processing elements; and transmit one or more signals indicating that the at least one data communication was served to the at least one processing element.

In some aspects, the techniques described herein relate to a very long instruction word machine, wherein: one or more processing elements that provide data in connection with processing the instruction are each configured to add at least one signal to a first aggregation of signals, the first count being based on the first aggregation of signals; and one or more processing elements that obtain data in connection with processing the instruction are each configured to add at least one signal to a second aggregation of signals, the second count being based on the second aggregation of signals.

In some aspects, the techniques described herein relate to a method comprising: compiling a program to generate instructions for processing by a plurality of processing elements of a very long instruction word machine; and during the compiling, populating fields of the instructions, the populating comprising: populating a first field that directs a processing element to communicate a first type of signal to an instruction controller of the very long instruction word machine in connection with providing data to one or more other processing elements to process a respective instruction; and populating a second field that directs the processing element to communicate a second type of signal to the instruction controller in connection with receiving data from one or more of the other processing elements to process the respective instruction.

In some aspects, the techniques described herein relate to a method, wherein the first field drives communication of the first type of signal based on a third type of signal being set in a data storage device of the very long instruction word machine, the third type of signal indicating that the processing element is configured to provide data to a remote processing element in connection with processing the respective instruction.

In some aspects, the techniques described herein relate to a method, wherein the second field drives communication of the second type of signal based on a fourth type of signal being set in a data storage device of the very long instruction word machine, the fourth type of signal indicating that the processing element received data from a remote processing element in connection with processing the respective instruction.

In some aspects, the techniques described herein relate to a method, wherein populating the fields of the instructions further includes populating a third field that identifies an instruction group of the respective instruction, the instruction group enabling the instruction controller to determine whether the instructions are dependent on the respective instruction and control dispatch of the instructions based on whether the instructions are dependent on the respective instruction.

In some aspects, the techniques described herein relate to a method, wherein populating the fields of the instructions further includes populating a fourth field that indicates a priority of the instruction group in relation to additional instruction groups, the priority enabling the instruction controller to determine an order of dispatch priority for the instructions and dispatch the instructions based on the order of dispatch priority.

In some aspects, the techniques described herein relate to a method, wherein populating the fields of the instructions further includes populating a third field that indicates a number of instruction cycles for which one or more processing elements are occupied with processing statically scheduled instructions, the number of instruction cycles enabling the processing element to delay providing the data to the one or more processing elements until the one or more processing elements complete processing the statically scheduled instructions.

In some aspects, the techniques described herein relate to a method, wherein populating the fields of the instructions further includes populating operation fields of the instructions with operations for execution by execution units of the plurality of processing elements to perform the operations on different data.

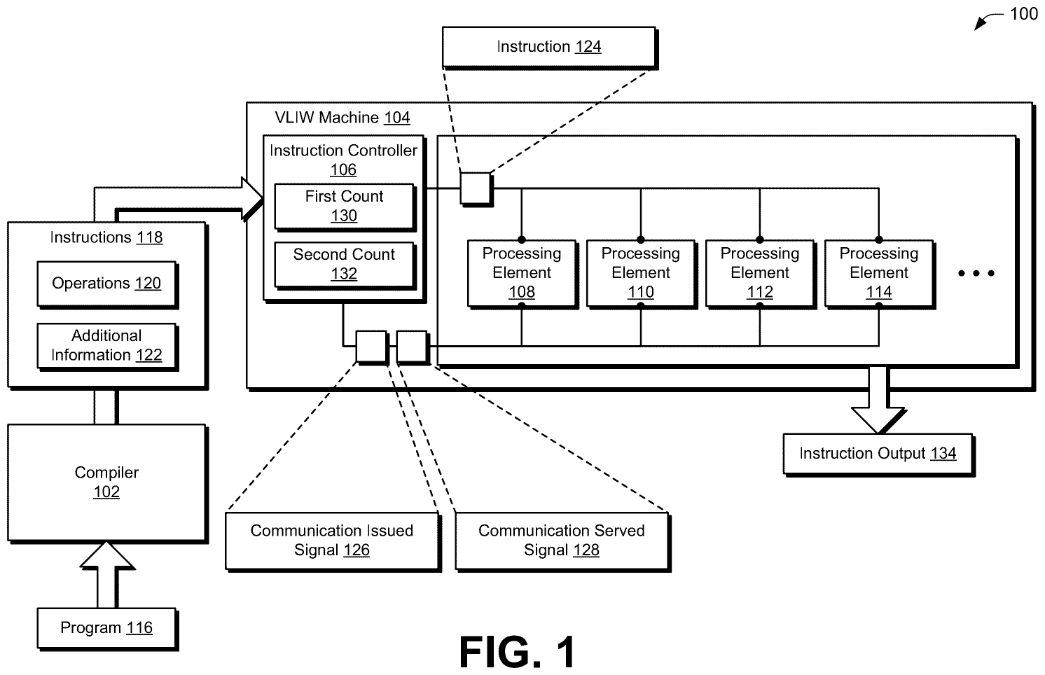

FIG. 1 is a block diagram of a non-limiting example system 100 having a compiler and a very long instruction word (VLIW) machine according to some implementations. In particular, the system 100 includes a compiler 102 and a VLIW machine 104, which includes an instruction controller 106 and processing elements 108, 110, 112, 114. In variations, the VLIW machine 104 includes different numbers of processing elements than depicted in FIG. 1 and described herein, e.g., tens, hundreds, thousands, or tens of thousands.

In accordance with the described techniques, the compiler 102 obtains a program 116 and compiles the program 116 to generate instructions 118 for the VLIW machine 104. In contrast to conventional approaches, which generate instructions by simply populating operation fields with operations to be executed by a VLIW machine, the compiler 102 generates the instructions 118 to include both operations 120 and additional information 122 for enabling the VLIW machine 104 to execute instructions 118 that cause dynamic communication of data to at least one of the processing elements 108, 110, 112, 114 of the VLIW machine 104. In one or more implementations, the instructions 118 are executed based on a fixed schedule, which is determined when the program 116 is compiled. In other words, the compiler 102 “statically identifies” an order for the instructions 118 to execute before the instructions 118 are executed by the VLIW machine 104. In comparison, other processor architectures utilize increased hardware complexity within the processor itself to “dynamically identify” an order for instructions to execute while the processor is executing the instructions. As a result, the VLIW machine 104 benefits from decreased hardware complexity and increased performance, e.g., due to lower instruction issue logic overhead, as compared to processor architectures that utilize dynamic instruction scheduling.

The instruction controller 106 receives the instructions 118 generated by the compiler 102 and dispatches an instruction 124 to the processing elements 108, 110, 112, 114. As mentioned above, the instruction 124 includes operation fields populated by the compiler 102 with the operations 120 for execution by the processing elements 108, 110, 112, 114. In one or more implementations, a respective processing element 108, 110, 112, 114 of the VLIW machine 104 executes each of the operations 120 included in the instruction 124 concurrently. For example, each processing element 108, 110, 112, 114 includes a same number of execution units and this corresponds to a number of the operation fields included in the instruction 124. In accordance with this functionality, each execution unit of the respective processing element 108, 110, 112, 114 is assigned a specific operation field of the instruction 124. Therefore, in processing the instruction 124, each execution unit of the respective processing element 108, 110, 112, 114 can concurrently execute the operation 120 included in its respective assigned operation field.

In one or more implementations, the execution units of the different processing elements 108, 110, 112, 114 execute the operations 120 of a single instruction concurrently, but the different processing elements 108, 110, 112, 114 execute the operations 120 of the single instruction on different data. This computer processing technique is known as Single Instruction, Multiple Data (SIMD) processing. By implementing SIMD processing, the VLIW machine 104 is able to process a single instruction, such as the instruction 124, concurrently on many data points, e.g., on as many data points as there are processing elements included in the VLIW machine 104. As a result, the VLIW machine 104 benefits from increased scalability as compared to other processor architectures.

Although depicted and described herein as a SIMD processor capable of processing data in a SIMD manner, it is to be appreciated that the VLIW machine 104 can be implemented using different processor architectures capable of processing data using different processing techniques. By way of example and not limitation, the VLIW machine 104 can be implemented as a Multiple Instruction, Multiple Data (MIMD) processor or a vector processor without departing from the spirit or scope of the described techniques.

In one or more implementations, the instruction 124 causes dynamic communication of data to at least one of the processing elements 108, 110, 112, 114 of the VLIW machine 104. By way of example, at least one processing element 108, 110, 112, 114 utilizes data from another processing element 108, 110, 112, 114 and/or a shared memory structure of the processing elements 108, 110, 112, 114 in connection with processing the instruction 124. The data utilized by the at least one processing element 108, 110, 112, 114, for example, is a result of processing the instruction 124 at a different processing element 108, 110, 112, 114. In some implementations, the processing elements 108, 110, 112, 114 each include a private memory. In accordance with these implementations, processing the instruction 124 involves communication of data from one or more of the processing elements 108, 110, 112, 114 to at least one other processing element 108, 110, 112, 114. In some implementations, the processing elements 108, 110, 112, 114 utilize a shared memory structure (not shown). In accordance with these implementations, processing the instruction 124 involves communication of data from the shared memory structure to the processing elements 108, 110, 112, 114. Alternatively or additionally, processing the instruction 124 involves communication of data from the processing elements 108, 110, 112, 114 to the shared memory structure.

Therefore, processing the instruction 124 involves communication of data from one or more of the processing elements 108, 110, 112, 114 to at least one other processing element 108, 110, 112, 114 and/or communication of data between the processing elements 108, 110, 112, 114 and a shared memory structure of the processing elements 108, 110, 112, 114. Thus, it is to be appreciated that “dynamic communication,” as depicted and described herein, encompasses both dynamic communication among the processing elements 108, 110, 112, 114 and dynamic communication between a shared memory structure and the processing elements 108, 110, 112, 114.

In some implementations, the processing elements 108, 110, 112, 114 involved in the dynamic communication of data are not statically known, e.g., when the program 116 is compiled. For instance, the processing elements 108, 110, 112, 114 that are to communicate data to at least one other processing element 108, 110, 112, 114 and/or the shared memory structure are not known at the time that the program 116 is compiled. Alternatively or in addition, the processing elements 108, 110, 112, 114 that are to receive data from at least one other processing element 108, 110, 112, 114 and/or the shared memory structure are not known at the time that the program is compiled. Additionally or alternatively, an order of execution for the processing elements 108, 110, 112, 114 and/or the shared memory structure is not known at the time the program is compiled.

For at least the above-noted reasons, dynamic communications can be communications of variable latency, e.g., the time it takes to process the dynamic communication is not known when the program 116 is compiled. As a result, conventional VLIW machines encounter challenges when statically scheduling instructions that depend on a result of an instruction that causes dynamic communication. For example, conventional techniques for enabling dynamic communication in VLIW machines assume worst-case communication latencies, thus limiting the scalability and performance advantages offered by VLIW machines.

As mentioned above and below, the instruction 124 includes the additional information 122 for enabling efficient dynamic communication among the processing elements 108, 110, 112, 114 and/or memory components of the VLIW machine 104. For example, in addition to populating operation fields specifying the operations 120 for execution by the VLIW machine 104, the compiler 102 populates a dynamic issue field for the instruction 124. The dynamic issue field directs one or more of the processing elements 108, 110, 112, 114 to issue a data communication to at least one other processing element 108, 110, 112, 114 in connection with processing the instruction 124. Notably, the processing elements 108, 110, 112, 114 that issue a data communication to other processing elements 108, 110, 112, 114 and/or the shared memory structure in connection with processing the instruction 124 may be referred to herein as “source processing elements.” The processing elements 108, 110, 112, 114 that receive a data communication from other processing elements 108, 110, 112, 114 and/or the shared memory structure in connection with processing the instruction 124 may be referred to herein as “destination processing elements.” Accordingly, the dynamic issue field directs the source processing elements to issue data communications that provide data to the destination processing elements.

The dynamic issue field of the instruction 124 further directs one or more of the processing elements 108, 110, 112, 114 to transmit one or more communication issued signals 126 to the instruction controller 106. For instance, the dynamic issue field directs the source processing elements to transmit a communication issued signal 126 to the instruction controller 106 in response to issuing a data communication to a destination processing element. The communication issued signal 126 indicates to the instruction controller 106 that a data communication was issued by a source processing element. In accordance with the described techniques, each respective source processing element is configured to transmit a number of communication issued signals 126 that corresponds to a number of data communications issued by the respective source processing element. Consider an example in which the instruction 124 causes a single source processing element to issue a number of data communications to a number of destination processing elements, e.g., three data communications to three destination processing elements. In this example, the dynamic issue field causes the single source processing element also to transmit a corresponding number of communication issued signals 126 to the instruction controller 106, e.g., three communication issued signals 126.

In addition to populating the dynamic issue field, the compiler 102 also populates a dynamic service field for the instruction 124. The dynamic service field directs at least one processing element 108, 110, 112, 114 to receive one or more data communications from one or more other processing elements 108, 110, 112, 114 in connection with processing the instruction 124. In other words, the dynamic service field prompts the destination processing elements to accept data communications from the source processing elements.

The dynamic service field of the instruction 124 further directs at least one of the processing elements 108, 110, 112, 114 to transmit one or more communication served signals 128 to the instruction controller 106. For instance, the dynamic service field directs the destination processing elements to transmit a communication served signal 128 to the instruction controller 106 in response to receiving a data communication from a source processing element. The communication served signal 128 indicates to the instruction controller 106 that a data communication was received by a destination processing element. In accordance with the described techniques, each respective destination processing element is configured to transmit a number of communication served signals 128 that corresponds to a number of data communications received by the respective destination processing element. Consider an example in which the instruction 124 causes a single destination processing element to receive a number of data communications from a number of source processing elements, e.g., three data communications from three source processing elements. In this example, the dynamic service field causes the single destination processing element also to transmit a corresponding number of communication served signals 128 to the instruction controller 106, e.g., three communication served signals 128.

Notably, the compiler 102 sets the dynamic issue field and the dynamic service field if it is possible for the instruction 124 to participate in a dynamic communication of data. However, it may not be known at the time the program 116 is compiled, whether the instruction 124 will in fact participate in the dynamic communication of data, and which processing elements 108, 110, 112, 114 will participate in the dynamic communication of data. Therefore, one or more previously executed instructions 118 direct the processing elements 108, 110, 112, 114 to determine their respective destination address in connection with processing the instruction 124. The destination address could be remote (e.g., another processing element and/or a shared memory structure) or a processing element can maintain the data without communicating the data to a remote destination.

Only the processing elements 108, 110, 112, 114 that are configured to provide data to a remote destination address will participate in the dynamic issue. Thus, in order to facilitate which processing elements 108, 110, 112, 114 will transmit a communication issued signal 126 to the instruction controller 106, the previously executed instruction 118 sets a remote request signal in a data storage device of the VLIW machine 104, e.g., via a flip-flop, latch, register, etc. The remote request signal(s) are set for each processing element 108, 110, 112, 114 that is requested to provide data to a remote destination address, e.g., a remote processing element. Therefore, the remote request signal(s) indicate which processing elements 108, 110, 112, 114 are to provide data to a remote destination address in connection with processing the instruction 124. In this way, the dynamic issue field can drive transmission of the communication issued signal 126 by a source processing element only if the remote request signal is also set for the source processing element. In contrast, the dynamic issue field will not drive transmission of the communication issued signal 126 by a processing element if the remote request signal is not set for the processing element.

Only the processing elements 108, 110, 112, 114 that receive data from a remote source address will participate in the dynamic service. Thus, in order to facilitate which processing elements 108, 110, 112, 114 will communicate a communication served signal 128, the instruction 124 sets a remote request received signal in a data storage device of the VLIW machine 104, e.g., via a flip-flop, latch, register, etc. The remote request received signal(s) are set for each processing element 108, 110, 112, 114 that receives data from a remote source address, e.g., a remote processing element. Therefore, the remote request received signal(s) indicate which processing elements 108, 110, 112, 114 have received data from a remote source address in connection with processing the instruction 124. In this way, the dynamic service field can drive transmission of the communication served signal 128 by a destination processing element only if the remote request received signal is also set for the destination processing element. In contrast, the dynamic service field will not drive transmission of the communication served signal 128 by a processing element if the remote request received signal is not set for the processing element. As a result, the dynamic issue field and the dynamic service field will only activate if the instruction 124 actually causes dynamic communication of data, and only for the processing elements 108, 110, 112, 114 that are involved in the dynamic communication of data.

Consider an example scenario in which the instruction 124 causes a dynamic communication pattern, in which processing element 114 requests data from processing elements 108 and 110. In accordance with this example, the compiler 102 sets the dynamic issue field and the dynamic service field for the instruction 124 without knowing whether the instruction 124 will actually cause a dynamic communication of data. Moreover, a previously executed instruction 118 directs the processing elements 108, 110, 112, 114 to determine their respective destination addresses. In this case, the destination addresses for processing elements 108 and 110 are remote, i.e., processing element 114. The previously executed instruction 118 also sets remote request signal(s) for processing elements 108 and 110 via a data storage device of the VLIW machine 104.

In this example scenario, the dynamic issue field of the instruction 124 directs each of the processing elements 108 and 110 to issue a data communication including the requested data to the processing element 114. In addition, the dynamic issue field drives transmission of a communication issued signal 126 by the processing elements 108 and 110 based on the remote request signal(s). Further, the dynamic service field of the instruction 124 directs processing element 114 to accept the data communications from the processing elements 108 and 110 which include the requested data. The instruction 124 also sets remote request received signal(s) for the processing element 114 in response to the processing element 114 actually receiving the data communications from the remote processing elements 108 and 110. The dynamic service field further drives transmission of two communication served signals 128 by the processing element 114 based on the remote request received signal(s)—one communication served signal 128 in response to receiving the data communication from the processing element 108 and one communication served signal 128 in response to receiving the data communication from the processing element 110.

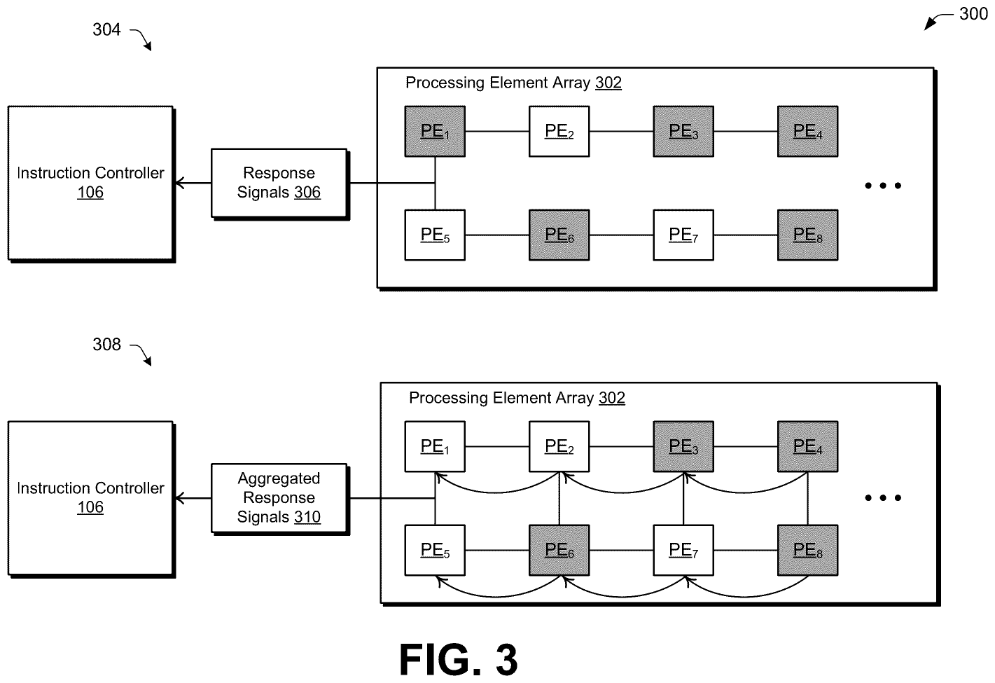

The instruction controller 106 is configured to receive the communication issued signals 126 from the source processing elements and the communication served signals 128 from the destination processing elements. As further discussed below with reference to FIG. 3, the instruction controller 106 is configured to receive the communication issued signals 126 and the communication served signals 128 via various mechanisms. Based on receipt of these signals, the instruction controller 106 maintains a first count 130 of the communication issued signals 126 and a second count 132 of the communication served signals 128. In at least one example, the instruction controller 106 increments the first count 130 in response to receiving a communication issued signal 126 and increments the second count 132 in response to receiving a communication served signal 128.

The first count 130 and the second count 132 enable the instruction controller 106 to determine whether processing associated with the dynamic communication of the instruction 124 has been completed. In some implementations, the instruction controller 106 determines that the first count 130 and the second count 132 are unequal, indicating to the instruction controller 106 that dynamic communication corresponding to the instruction 124 is still ongoing. For example, in various scenarios, the first count 130 of communication issued signals 126 is greater than the second count 132 of communication served signals 128. This indicates that at least one destination processing element has not yet received a data communication from the source processing elements in connection with processing the instruction 124. When all outstanding dynamic communication requests have been issued and served, the first count 130 and the second count 132 are equal. This indicates (e.g., to the instruction controller 106) that the dynamic communications which enable the destination processing elements to process the instruction 124 have been completed.

The instruction controller 106 determines at least one additional instruction 118 to dispatch based on a comparison of the first count 130 and the second count 132. In one or more implementations, the instruction controller 106 determines an additional instruction 118 to dispatch that is independent of the instruction 124 while the first count 130 and the second count 132 are unequal. The additional instruction 118 is considered “independent” of the instruction 124 if the additional instruction 118 does not rely on an instruction output 134 of the instruction 124 to process the additional instruction 118. Notably, the instruction output 134 of the instruction 124 corresponds to a result of processing the instruction 124 at any one or any combination of the processing elements 108, 110, 112, 114 of the VLIW machine 104. In some implementations, the instruction controller 106 determines an additional instruction 118 to dispatch that is dependent on the instruction 124 based on the first count 130 and the second count 132 being equal. The additional instruction 118 is considered “dependent” on the instruction 124 if the additional instruction 118 relies on the instruction output 134 of the instruction 124 to process the additional instruction.

In an example, the instruction controller 106 determines that the first count 130 and the second count 132 are unequal, indicating to the instruction controller 106 that the dynamic communication caused by the instruction 124 is ongoing. Thus, the instruction controller 106 determines to dispatch an independent, additional instruction 118. In another example, the instruction controller 106 determines that the first count 130 and the second count 132 are equal, indicating to the instruction controller 106 that the dynamic communication caused by the instruction 124 is complete. Thus, the instruction controller 106 determines to dispatch a dependent, additional instruction 118.

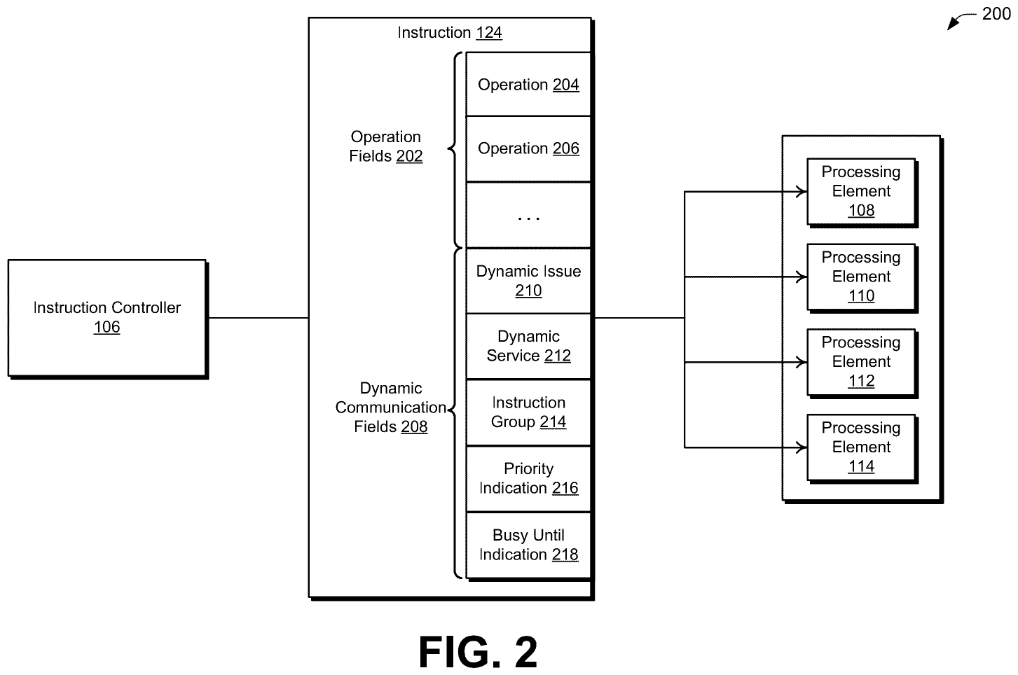

FIG. 2 depicts a non-limiting example 200 in which a VLIW machine executes an instruction that includes dynamic communication fields populated with information for enabling dynamic communication. Example 200 includes from FIG. 1, the instruction controller 106, the instruction 124, and the processing elements 108, 110, 112, 114. The instruction 124, as depicted in the illustrated example 200, also includes operation fields 202, which the compiler 102 populates with operations 204, 206 for execution by the processing elements 108, 110, 112, 114 of the VLIW machine 104. Moreover, the instruction 124, as depicted in the illustrated example 200, also includes dynamic communication fields 208, which the compiler 102 populates with the additional information 122 for enabling the VLIW machine 104 to execute the instruction 124 that causes dynamic communication of data to at least one of the processing elements 108, 110, 112, 114 of the VLIW machine 104.

In accordance with the described techniques, the instruction controller 106 dispatches the instruction 124, which includes the operation fields 202 populated with operations 204, 206. Notably, each operation field 202 represents a specific operation 204, 206 to be executed by the processing elements 108, 110, 112, 114. By way of example, the operation 204 can represent functionality to cause the processing elements 108, 110, 112, 114 to perform an “add” operation, while the operation 206 can represent functionality to cause the processing elements 108, 110, 112, 114 to perform a “subtract” operation. Notably, the instruction 124 is illustrated as including two operation fields 202 populated with two operations 204, 206 for illustrative purposes. It should be noted, however, that the instruction 124 can include any number of operation fields 202 populated with any number of operations 204, 206 without departing from the spirit or scope of the described techniques. As further discussed above with reference to FIG. 1, each of the processing elements 108, 110, 112, 114 of the VLIW machine 104 can concurrently perform each of the operations 204, 206 included in the operation fields 202 of the instruction 124 on different data, e.g., in a SIMD manner.

In addition to including the operation fields 202 for the operations 204, 206, the instruction 124 also includes dynamic communication fields 208 to enable efficient dynamic communication between the processing elements 108, 110, 112, 114 and/or memory components of the VLIW machine 104. For example, the compiler 102 populates one of the dynamic communication fields 208 with a dynamic issue 210. As discussed above, the dynamic issue 210 directs the source processing elements to provide data to the destination processing elements in connection with processing the instruction 124. The dynamic issue 210 also directs the source processing elements to transmit a communication issued signal 126 to the instruction controller 106 in response to issuing a data communication. Moreover, the compiler 102 populates one of the dynamic communication fields 208 with a dynamic service 212. As discussed above, the dynamic service 212 directs the destination processing elements to receive data from the source processing elements in connection with processing the instruction 124. The dynamic issue 210 also directs the destination processing elements to transmit a communication served signal 128 to the instruction controller 106 in response to receiving a data communication.

Notably, a processing element 108, 110, 112, 114 can act as both a destination processing element and a source processing element in processing the instruction 124. By way of example, in addition to requesting data from processing elements 108, 110 in connection with processing the instruction 124, processing element 114 can also be requested to provide data to processing element 112 in connection with processing the instruction 124. In this example, the dynamic service 212 directs the processing element 114 to communicate communication served signals 128 in response to receiving the requested data from processing elements 108, 110. Furthermore, the dynamic issue 210 directs the processing element 114 to communicate a communication issued signal 126 in response to providing the requested data to processing element 112.

In one or more implementations, the compiler 102 populates one of the dynamic communication fields 208 with an instruction group 214. In addition to populating the dynamic communication fields of the instruction 124 with an instruction group 214, the compiler 102 also populates dynamic communication fields of each instruction 118 generated by the compiler 102 with an instruction group 214. Notably, an instruction group 214 includes one or more instructions 118 that rely on instruction outputs of other instructions 118 in the respective instruction group 214. In other words, the compiler 102 groups sets of dependent instructions in a same instruction group 214. In some implementations, an instruction group 214 can include a plurality of instructions that each rely on an instruction output of at least one other instruction in the instruction group 214. Additionally or alternatively, an instruction group can include only a single instruction that does not rely on data from other instructions in order to process the single instruction.

In accordance with the described techniques, the instruction group 214 of the instruction 124 enables the instruction controller 106 to determine whether additional instructions 118 are dependent on the instruction 124 and control dispatch of the additional instructions 118 based on whether the additional instructions 118 are dependent on the instruction 124. For example, the instruction controller 106 determines that an additional instruction 118 is independent of the instruction 124 if the dynamic communication fields 208 of the instruction 124 and the additional instruction 118 indicate different instruction groups 214. This enables the instruction controller 106 to select the independent, additional instruction 118 for dispatch while the first count 130 and the second count 132 are unequal. Additionally or alternatively, the instruction controller 106 determines that an additional instruction 118 is dependent on the instruction 124 if the dynamic communication fields 208 of the instruction 124 and the additional instruction 118 indicate a same instruction group 214. This enables the instruction controller 106 to select the dependent, additional instruction 118 based on the first count 130 and the second count 132 being equal.

The instruction group 214 of the instruction 124 also directs the processing elements 108, 110, 112, 114 to communicate communication issued signals 126 and communication served signals 128 with an instruction group identifier. For example, the communication issued signals 126 and the communication served signals 128 are communicated to the instruction controller 106 with an instruction group identifier that identifies the instruction group 214 of the instruction 124.

The instruction group identifier enables the instruction controller 106 to maintain first and second counts 130, 132 for multiple instructions that are concurrently dispatched to the processing elements 108, 110, 112, 114. As previously discussed, the instruction controller 106 can dispatch an independent, additional instruction 118 of a different instruction group 214 while the first count 130 and the second count 132 of the instruction 124 are unequal. In some situations, the independent, additional instruction 118 of the different instruction group 214 also causes dynamic communication of data to at least one of the processing elements 108, 110, 112, 114. In other words, there are situations in which multiple different dynamic communication patterns are “in-flight” simultaneously. In these situations, the instruction controller 106 leverages the instruction group identifier of the received communication issued signals 126 and the received communication served signals 128 to ensure that the first and second counts 130, 132 are updated for the correct instruction.

By way of example, the instruction controller 106 updates the first and second counts 130, 132 for the instruction 124 based on communication issued signals 126 and communication served signals 128 received with an instruction group identifier that identifies the instruction group 214 of the instruction 124. Furthermore, the instruction controller 106 does not increment the first and second counts 130, 132 for the instruction 124 based on communication issued signals 126 and communication served signals 128 received with an instruction group identifier that identifies the instruction group 214 of the independent, additional instruction 118. Rather, the instruction controller 106 maintains separate first and second counts 130, 132 for the independent, additional instruction 118 and increments the first and second counts 130, 132 of the independent, additional instruction 118 based on communication issued signals 126 and communication served signals 128 that are received with an instruction group identifier that identifies the instruction group 214 of the independent, additional instruction 118.

In one or more implementations, the compiler 102 populates one of the dynamic communication fields 208 with a priority indication 216 that indicates a priority of the instruction group 214 of the instruction 124 in relation to other instruction groups 214. In addition to populating the instruction 124 with a priority indication 216, the compiler 102 also populates each of the instructions 118 generated by the compiler 102 with a priority indication 216. In some implementations, the compiler 102 determines the priority indication 216 for the instructions 118 during a compiler pass that determines priority based on dependencies of the instructions 118. Additionally or alternatively, the priority indication 216 can be generated by the compiler 102 based on compiler hints and/or compiler directives.

The priority indication enables the instruction controller 106 to determine an order of dispatch priority for the instructions 118 and dispatch the instructions 118 based on the order of dispatch priority. For instance, when multiple instructions 118 are eligible to be dispatched in a given instruction cycle, the instruction controller 106 dispatches the instruction 118 of the multiple instructions 118 that is associated with a higher priority. Notably, in accordance with SIMD processing, one instruction 118 is dispatched to each of the processing elements 108, 110, 112, 114 of the VLIW machine 104 every instruction cycle. Thus, in one or more implementations, one instruction cycle corresponds to dispatch of one instruction 118 to each of the processing elements 108, 110, 112, 114.

Consider an example in which, prior to dispatching the instruction 124, a prior instruction is dispatched that causes dynamic communication to a source processing element. In accordance with this example, the instruction controller 106 determines to dispatch an independent, additional instruction while the first count 130 and the second count 132 are unequal. However, both the instruction 124 and an additional instruction 118 are eligible to be dispatched, e.g., both the instruction 124 and the additional instruction 118 are associated with different instruction groups 214 than the prior instruction. In this example, the instruction 124 is associated with a first instruction group 214 while the additional instruction 118 is associated with a second instruction group 214. Further, the priority indications 216 of the instruction 124 and the additional instruction 118 indicate that the first instruction group 214 is associated with a higher priority than the second instruction group 214. Therefore, the instruction controller 106 determines to dispatch the instruction 124, rather than the additional instruction 118. Additionally or alternatively, the instruction controller 106 can determine which instruction 118 to dispatch of multiple instructions 118 that are eligible to be dispatched in a given instruction cycle using runtime heuristics, such as round-robin, random, oldest first, and so forth.

In one or more implementations, the compiler 102 populates one of the dynamic communication fields 208 with a busy until indication 218 that indicates a number of instruction cycles for which one or more processing elements 108, 110, 112, 114 are occupied with processing statically scheduled instructions. For instance, the busy until indication 218 specifies which of the processing elements 108, 110, 112, 114 are scheduled to be busy executing statically scheduled instructions. Further, the busy until indication 218 specifies a number of instruction cycles for which each of the occupied processing elements 108, 110, 112, 114 are scheduled to be busy executing the statically scheduled instructions. The number of instruction cycles, for example, can be encoded in the busy until indication 218 as a cycle offset that indicates a number of instruction cycles relative to the instruction cycle that dispatches the instruction 124.

The busy until indication further enables the source processing elements to delay providing data to the occupied destination processing elements until the occupied destination processing elements complete processing the statically scheduled instructions. To do so, each of the processing elements 108, 110, 112, 114 include an arbitration unit configured to leverage the busy until indication 218 of the instruction 124 to stall issuing a dynamic communication to a destination processing element, indicated as busy by the busy until indication 218, until the destination processing element finishes processing a number of statically scheduled instructions, indicated by the number of cycles encoded in the busy until indication 218.

Consider an example in which the instruction 124 is a statically scheduled instruction, and the busy until indication 218 indicates that processing element 114 will be occupied processing statically scheduled instructions for a specified number of instruction cycles, e.g., five instruction cycles. In this example, processing element 108 receives a dynamic communication request to dynamically communicate data to processing element 114 within the specified number of instruction cycles, e.g., during the third instruction cycle of the five instruction cycles. In accordance with this example, the arbitration unit of processing element 108 leverages the busy until indication 218 of the instruction 124 to determine that processing element 114 is occupied processing statically scheduled instructions for at least one more instruction cycle. Therefore, processing element 108 delays providing the requested data to processing element 114 for the remainder of the specified number of instruction cycles, e.g., for the third, fourth, and fifth instruction cycles. Then, the processing element 108 can provide the requested data to processing element 114 when the specified number of instruction cycles are completed, e.g., on the sixth instruction cycle from the instruction cycle in which the instruction 124 was dispatched.

In implementations in which the processing elements 108, 110, 112, 114 each include a private memory, each of the processing elements 108, 110, 112, 114 include an arbitration unit. Additionally or alternatively, in implementations in which the processing elements 108, 110, 112, 114 utilize a shared memory structure, the shared memory structure can include one or more arbitration units. Therefore, the busy until indication 218 enables dynamic communication of data to the at least one destination processing element to be delayed regardless of whether the data is dynamically communicated by the processing elements 108, 110, 112, 114, the shared memory structure, or both.

By delaying dynamic communication to destination processing elements that are occupied with processing statically scheduled instructions, the arbitration units of the processing elements 108, 110, 112, 114 ensure that dynamic communication does not interrupt statically scheduled instructions. In other words, the statically scheduled instructions can be executed in accordance with the fixed schedule determined by the compiler 102 without the fixed schedule being interrupted by dynamic communications of variable latency. By doing so, dynamic communication is enabled for the VLIW machine 104 without requiring a disruptive pivot away from the static scheduling associated with VLIW machines. Accordingly, the VLIW machine 104 benefits from the advantages offered by VLIW machines due to their static nature, such as reduced instruction issue overhead and reduced hardware complexity, while enabling dynamic communication for the VLIW machine 104.

In one or more implementations, the arbitration units can also implement an explicit scoreboard that is populated by the instruction controller 106. In this way, the arbitration units can leverage the information in the explicit scoreboard to arbitrate between different instances of dynamic communication (e.g., dynamic communication patterns associated with different instruction groups 214) that are in-flight simultaneously and requesting a same processing element 108, 110, 112, 114.

FIG. 3 depicts a non-limiting example 300 in which signals are communicated from a processing element array to an instruction controller according to some implementations. Example 300 includes, from FIGS. 1 and 2, the instruction controller 106. The illustrated example 200 also includes a processing element array 302, which includes a plurality of processing elements, such as processing elements 108, 110, 112, 114 of FIGS. 1 and 2. Although depicted as including eight processing elements, the processing element array 302 can include any suitable number of processing elements, e.g., hundreds, thousands, tens of thousands of processing elements, without departing from the spirit or scope of the described techniques.

In a first example 304, the instruction controller 106 is depicted as receiving response signals 306 from individual processing elements of the processing element array 302. The response signals 306 for instance, are communication issued signals 126 or communication served signals 128. In the example 304, PE₁, PE₃, PE₄, PE₆, and PE₈ of the processing element array 302 are illustrated in a darker shade to show that these processing elements are involved in a dynamic communication of data. For example, each of the individual processing elements PE₁, PE₃, PE₄, PE₆, and PE₈ are providing data to another processing element, receiving data from another processing element, or both, in connection with processing an instruction.

In accordance with this example 304, each of the processing elements PE₁, PE₃, PE₄, PE₆, and PE₈ are configured to transmit a response signal 306 directly to the instruction controller 106 in response to providing the requested data and/or receiving the requested data. Therefore, the instruction controller 106 receives a number of response signals 306 that corresponds to the number of data communications issued and received by the processing elements involved in the dynamic communication of data. For example, the instruction controller 106 receives at least one response signal 306 from PE₁, PE₃, PE₄, PE₆, and PE₈. The instruction controller 106 updates the first count 130 and the second count 132, e.g., by an increment of one, for each response signal 306 received.

In a second example 308, the instruction controller 106 is depicted as receiving aggregated response signals 310 from the processing element array 302. The aggregated response signals 310, for instance, are aggregated totals of communication issued signals 126 communicated by one or more of the processing elements in the processing element array 302. Additionally or alternatively, the aggregated response signals 310 are aggregated totals of communication served signals 128 communicated by one or more of the processing elements in the processing element array 302. In the example 308, PE₃, PE₄, PE₆, and PE₈ of the processing element array 302 are illustrated in a darker shade to show that these processing elements are involved in a dynamic communication of data. For example, each of the individual processing elements PE₃, PE₄, PE₆, and PE₈ are providing data to another processing element, receiving data from another processing element, or both, in connection with processing an instruction, such as instruction 124.

In one or more implementations, the processing element array 302 is topologically sorted, and the communication issued signals 126 and the communication served signals 128 are aggregated in a side-to-side (or bottom-up) manner along the topologically sorted processing element array 302. In such implementations, each level boundary of the processing element array 302 is configured to wait for an aggregated response signal 310 from the level boundaries of the processing element array 302 that are topologically further from the instruction controller 106. Notably, a “level boundary” is a group of processing elements in the processing element array 302 that are topologically sorted in a same position relative to the instruction controller 106. Upon receipt of the aggregated response signal 310, the processing elements within the level boundary that are involved in a dynamic communication are configured to add at least one signal to the aggregated response signal 310 before communicating the aggregated response signal to the level boundary that is topologically closer to the instruction controller 106. Notably, the aggregated response signal 310 remains at the level boundary until all of the processing elements within the level boundary complete their dynamic communication function, i.e., issuing a data communication and/or receiving a data communication. If there are no processing elements within the level boundary that are involved in the dynamic communication, then the aggregated response signal 310 can immediately be passed to the next level boundary of the processing element array 302 without any signals being added to the aggregated response signal.

In the second example 308, the processing elements of the processing element array 302 are arranged in a two-dimensional mesh, such that the instruction controller 106 is positioned on a left side of the processing element array 302. Each column of processing elements in the processing element array 302 is, therefore, a level boundary and is configured to wait for an aggregated response signal 310 from a rightward proximate column of processing elements, update the aggregated response signal 310, and pass the updated aggregated response signal 310 to a leftward proximate column of processing elements. In one or more implementations, the aggregated response signal 310 is maintained separately for the communication issued signals 126 and the communication served signals 128. Therefore, the processing element array 302 communicates to the instruction controller 106, a first aggregated response signal 310 indicating a count of communication issued signals 126 communicated by the processing element array 302 and a second aggregated response signal 310 indicating a count of communication served signals communicated by the processing element array 302.

Consider example 308 in which PE₄ and PE₆ each issue two data communications—one data communication to PE₃ and one data communication to PE₈ in connection with processing an instruction. In accordance with this example, the column of the processing element array 302 including PE₄ and PE₈ receives a first aggregated response signal 310 indicating an aggregated total of communication issued signals 126 from a rightward proximate column of the processing element array 302. Upon receiving the first aggregated response signal 310, PE₄ has not completed issuing data communications to PE₃ and PE₈. Therefore, the first aggregated response signal 310 remains at the column of the processing element array 302 including PE₄ and PE₈ while PE₄ completes issuing the data communications to PE₃ and PE₈. In response, PE₄ adds two communication issued signals 126 to the first aggregated response signal 310. Since PE₈ is only receiving data communications in connection with processing the instruction and not issuing any data communications, the first aggregated response signal 310 can then be passed to the column of the processing element array 302 including PE₃ and PE 7.

Since PE 7 is not involved in the dynamic communication of data and PE₃ is only receiving data communications in connection with processing the instruction, the first aggregated response signal 310 can immediately be passed to the column of the processing element array 302 including PE 2 and PE₆ without any additional signals being added to the first aggregated response signal 310. Upon receiving the first aggregated response signal, PE 6 has already completed issuing data communications to PE₃ and PE₈. Since PE₂ is not involved in the dynamic communication, PE₆ can add two communication issued signals 126 to the first aggregated response signal 310 and the first aggregated response signal 310 can be passed to the column of the processing element array 302 including PE₁ and PE₅. Since neither PE₁ nor PE₅ are involved in the dynamic communication of data, the first aggregated response signal 310, indicating a count of four communication issued signals 126, can immediately be passed to the instruction controller 106. A second aggregated response signal 310 indicating an aggregated total of four communication served signals 128 can similarly be propagated through the processing element array 302 and received by the instruction controller 106.

In accordance with the described techniques, the instruction controller 106 receives the aggregated response signals 310 and updates the first count 130 and the second count 132 based on the aggregated response signals 310. For example, the instruction controller 106 receives the first aggregated response signal 310 from the processing element array 302, indicating four communication issued signals 126, and updates the first count 130 by a count of four. Similarly, the instruction controller 106 receives the second aggregated response signal 310 from the processing element array 302, indicating four communication served signals 128, and updates the second count 132 by a count of four.

In one or more implementations, the processing element array 302 communicates only one aggregated response signal 310 that indicates a count of communication issued signals 126 and a count of communication served signals 128 communicated by the processing element array 302 in processing a respective instruction. For example, the aggregated response signal 310 indicates a first aggregation of communication issued signals 126 and a second aggregation of communication served signals 128. The instruction controller 106 then increments the first count 130 based on the first aggregation of communication issued signals 126 included in the aggregated response signal 310, and also increments the second count 132 based on the second aggregation of communication served signals 128 included in the aggregated response signal 310.

In some implementations, the processing elements of the processing element array 302 that are topologically closer to the instruction controller 106 are implemented with progressively wider links than processing elements of the processing element array 302 that are topologically further from the instruction controller 106. For example, the network of data paths used to facilitate the communication of the response signals 306 and/or the aggregated response signals 310 is implemented with fat-tree topology. This avoids over-provisioning at the processing elements that are topologically further from the instruction controller 106, and as such, conserves power and area.

In one or more implementations, it is statically known that dynamic communication does not cross level boundaries of the network of data paths used to facilitate the communication of the response signals 306 and/or the aggregated response signals 310. In other words, it is statically known that any dynamic communication caused by an instruction is strictly between processing elements of the same level boundary. Thus, in accordance with example 308, it is known at the time the program 116 is compiled that PE₄ and PE₈ only communicate with each other, PE₃ and PE₇ only communicate with each other, PE₂ and PE₆ only communicate with each other, and PE₁ and PE₅ only communicate with each other in connection with processing an instruction.

In accordance with these implementations, the aggregated response signal 310 can be a single-bit acknowledgement that only crosses level boundaries when a count of communication issued signals 126 matches a count of communication served signals 128 for a particular level boundary. By way of example, the aggregated response signal 310 is only passed from the PE₄-PE₈ column to the PE₃-PE₇ column once the count of communication issued signals 126 matches the count of communication served signals 128 for the PE₄-PE₈ column. In one or more implementations, the aggregated response signal 310 can be a multi-bit acknowledgement that indicates a count of communication issued signals 126 and/or a count of communication served signals 128 for all level boundaries of the processing element array 302, as discussed above. In some situations, the compiler 102 directs the processing element array 302 to implement either a single-bit acknowledgement or a multi-bit acknowledgement depending on static information regarding dynamic communication boundaries.

For example, the compiler 102 determines that an instruction causes dynamic communication that does not cross level boundaries of the processing element array 302 and populates an additional field of the instruction that directs the processing element array 302 to implement a single-bit aggregated response signal 310. In another example, the compiler 102 determines that an instruction causes dynamic communication that does cross level boundaries of the processing element array 302 and populates an additional field of the instruction that directs the processing element array 302 to implement a multi-bit aggregated response signal 310.

In one or more implementations, the response signals 306 and/or the aggregated response signals 310 are propagated through the processing element array 302 using data paths of the existing network topology. For example, the response signals 306 and/or the aggregated response signals 310 can be propagated through the processing element array 302 using data paths that are also used to facilitate data communications between the processing elements in the processing element array 302. Additionally or alternatively, a sideband network is included in the processing element array 302 for dedicated transmission of the response signals 306 and/or the aggregated response signals 310. By way of example, the response signals 306 and/or the aggregated response signals 310 can be communicated via a set of dedicated data paths that only facilitate the communication of the response signals 306 and/or the aggregated response signals 310.

In one or more implementations, the dedicated sideband network can be implemented using three-dimensional stacking, such that the dedicated sideband network is stacked on top of or below the computational and/or memory structures of the processing elements of the processing element array 302. This reduces routing complexities and reduces area overheads in implementing such a dedicated sideband network. Since the bandwidth required of the dedicated sideband network is relatively low, the dedicated sideband network can be implemented with a high degree of connectivity to reduce latency in transmitting the response signals 306 and/or the aggregated response signals 310. This leads to reduced contention, as well as increased computational efficiency and performance.

The dedicated sideband network also prevents premature matching of the first count 130 and the second count 132 based on congestion-based delays of the communication issued signals 126. In some situations, for example, the communication issued signals 126 transmitted through the existing topology of the processing element array 302 encounter congestion caused by data communications also being transmitted through the existing topology of the processing element array 302. In these situations, the first count 130 and the second count 132 can match despite the instruction controller 106 not receiving all the communication issued signals 126 or all of the communication served signals 128 transmitted by the processing elements in connection with processing an instruction. Accordingly, in these situations, the instruction controller 106 may prematurely dispatch a dependent, additional instruction. By implementing the dedicated sideband network, the communication issued signals 126 and the communication served signals 128 do not encounter congestion based on data communications among the processing elements, thus preventing any premature matching of the first count 130 and the second count 132. This ensures correct execution of additional instructions that depend on a result of the instruction that causes dynamic communication of data.

In the absence of a dedicated sideband network, premature matching of the first count 130 and the second count 132 can be prevented in other ways. In one example, the communication issued signals 126 are prioritized throughout the existing network topology of the processing element array 302. In this example, the communication issued signals 126 are given first priority to use the data paths of the existing network topology of the processing element array 302. Thus, when congestion exists, the communication issued signals 126 are transmitted via the data paths first while other communications, such as the communication served signals 128 and data communications, are transmitted via the data paths after the communication issued signals 126. Additionally or alternatively, the instruction controller 106 can implement a programmable time-out to safeguard against premature matching of the first count 130 and the second count 132. In accordance with this functionality, the instruction controller 106 waits for additional communication issued signals 126 and/or additional communication served signals 128 for a predefined amount of time in response to determining that the first count 130 and the second count 132 are equal. If the first count 130 and the second count 132 are not incremented during the predefined amount of time, the instruction controller 106 can dispatch a dependent, additional instruction.

This section describes examples of procedures for VLIW dynamic communication. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

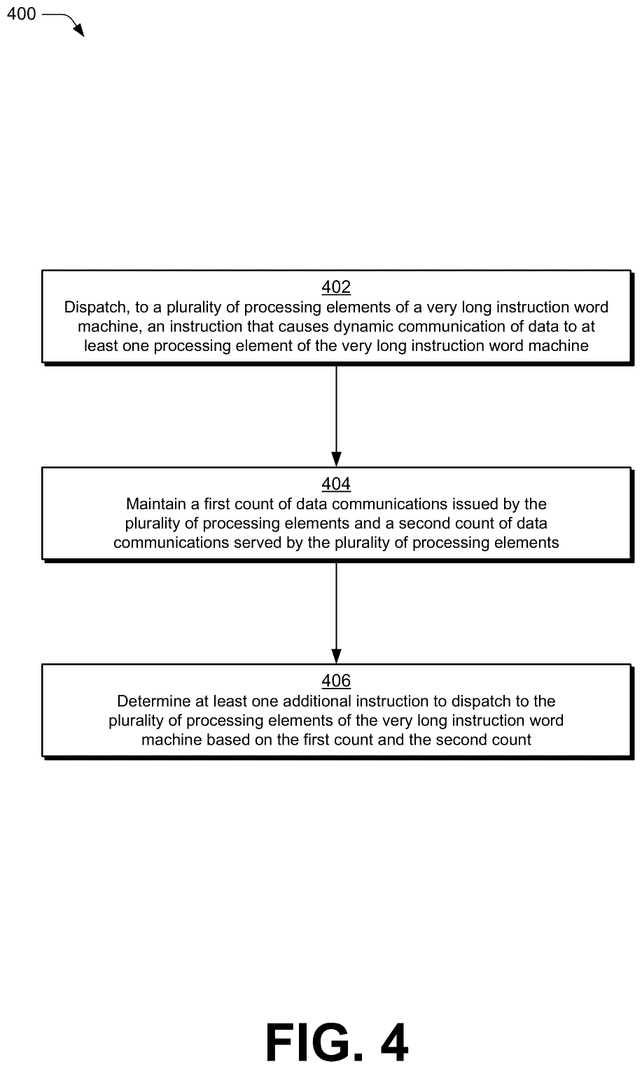

FIG. 4 depicts a procedure 400 in an example implementation of determining at least one additional instruction to dispatch to a plurality of processing elements based on a first count of data communications issued and a second count of data communications served.

An instruction that causes dynamic communication of data to at least one processing element of a very long instruction word machine is dispatched to a plurality of processing elements of the very long instruction word machine (block 402). By way of example, the instruction controller 106 dispatches the instruction 124, which causes one or more source processing elements to issue data communications to at least one destination processing element in connection with processing the instruction 124.

A first count of data communications issued by the plurality of processing elements and a second count of data communications served by the plurality of processing elements are maintained (block 404). In one or more implementations, the instruction controller 106 receives communication issued signals 126 from the source processing elements and communication served signals 128 from the destination processing elements. The instruction controller 106 maintains the first count 130 based on the received communication issued signals 126 and also maintains the second count 132 based on the received communication served signals 128.

At least one additional instruction is determined for dispatch to the plurality of processing elements based on the first count and the second count (block 406). By way of example, the instruction controller 106 determines at least one additional instruction to dispatch to the processing elements 108, 110, 112, 114 based on whether the first count 130 and the second count 132 are equal or unequal.

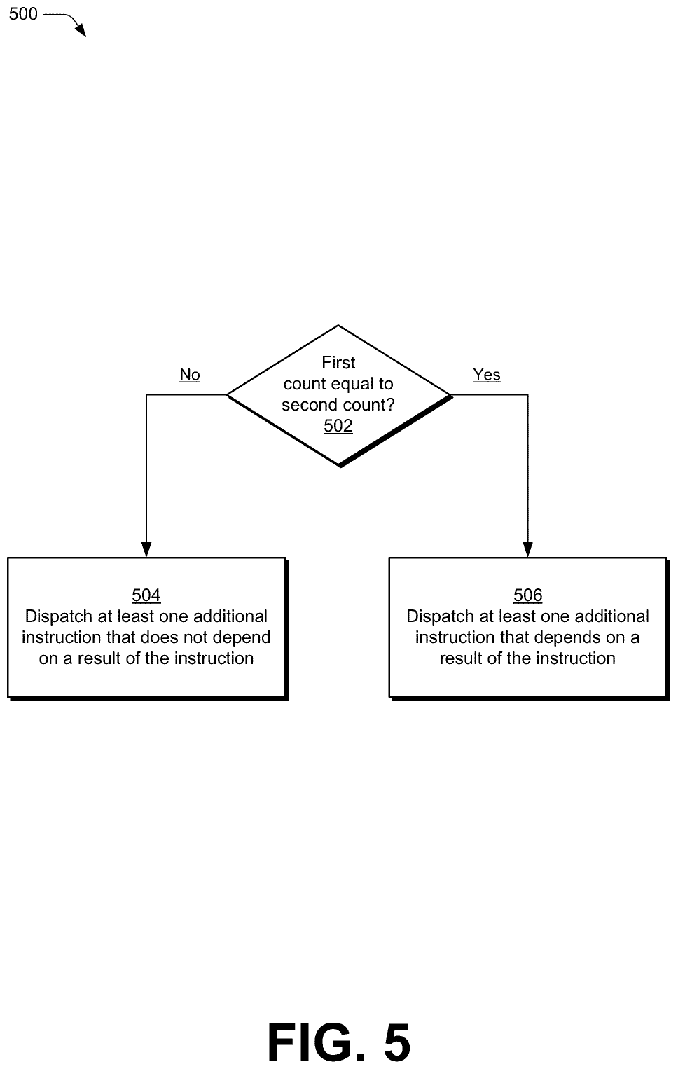

FIG. 5 depicts a procedure 500 in an example implementation of dispatching an independent instruction or a dependent instruction based on whether the first count is equal to the second count.

It is determined whether the first count is equal to the second count (block 502). By way of example, the instruction controller 106 compares the first count 130 and the second count 132 to determine whether the first count 130 is equal to the second count 132. In response to determining that the first count 130 and the second count 132 are not equal, i.e., “No” at block 502, at least one additional instruction that does not depend on a result of the instruction is dispatched (block 504). By way of example, the instruction controller 106 determines to dispatch at least one additional instruction 118 that is independent of the instruction 124 while the first count 130 and the second count 132 are unequal. In one or more implementations, the additional instruction 118 is determined to be independent of the instruction 124 based on instruction group fields of the instruction 124 and the additional instruction 118 indicating different instruction groups.

In response to determining that the first count 130 and the second count 132 are equal, i.e., “Yes” at block 502, at least one additional instruction that depends on a result of the instruction is dispatched (block 506). By way of example, the instruction controller 106 determines to dispatch at least one additional instruction 118 that is dependent on the instruction 124 based on the first count 130 and the second count 132 being equal. In one or more implementations, the additional instruction 118 is determined to be dependent on the instruction 124 based on instruction group fields of the instruction 124 and the additional instruction 118 indicating a same instruction group.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the compiler 102, the VLIW machine 104, the instruction controller 106, the processing elements 108, 110, 112, 114, and the processing element array 302) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

1. A method comprising:
dispatching, to a plurality of processing elements of a very long instruction word machine, an instruction that causes dynamic communication of data to at least one processing element of the very long instruction word machine;
maintaining a first count of data communications issued by the plurality of processing elements and a second count of data communications served by the plurality of processing elements; and
determining at least one additional instruction to dispatch to the plurality of processing elements of the very long instruction word machine based on the first count and the second count.

2. The method of claim 1, wherein the at least one additional instruction is independent of the instruction and is dispatched while the first count and the second count are unequal.

3. The method of claim 2, further comprising determining that the at least one additional instruction is independent of the instruction based on an instruction group field of the instruction and the at least one additional instruction indicating different instruction groups.

4. The method of claim 1, wherein the at least one additional instruction is dependent on the instruction and is determined for dispatching based on the first count and the second count being equal.

5. The method of claim 4, further comprising determining that the at least one additional instruction is dependent on the instruction based on an instruction group field of the instruction and the at least one additional instruction indicating a same instruction group.

6. The method of claim 1, wherein at least one data communication is issued by one or more processing elements to provide data to the at least one processing element in connection with processing the instruction.

7. The method of claim 6, further comprising:
incrementing the first count responsive to receiving a signal indicating that the one or more processing elements issued the at least one data communication; and
incrementing the second count responsive to receiving a signal indicating that the at least one processing element received the at least one data communication.

8. The method of claim 1, further comprising:
receiving a first aggregation of signals from one or more processing elements that provide data in connection with processing the instruction, the first count being based on the first aggregation of signals; and
receiving a second aggregation of signals from one or more processing elements that obtain data in connection with processing the instruction, the second count being based on the second aggregation of signals.

9. A very long instruction word machine comprising:
a plurality of processing elements; and
an instruction controller to:
dispatch, to the plurality of processing elements of the very long instruction word machine, an instruction that causes dynamic communication of data to at least one processing element of the very long instruction word machine;
maintain a first count of data communications issued by the plurality of processing elements and a second count of data communications served by the plurality of processing elements;
compare the first count and the second count; and
determine at least one additional instruction to dispatch to the plurality of processing elements of the very long instruction word machine based on a comparison of the first count and the second count.

10. The very long instruction word machine of claim 9, wherein the instruction includes a set of operations and each processing element of the plurality of processing elements is configured to perform the set of operations on different data.

11. The very long instruction word machine of claim 9, wherein one or more processing elements are configured to:
issue at least one data communication to provide data to the at least one processing element in connection with processing the instruction; and
transmit one or more signals indicating that the at least one data communication was issued by the one or more processing elements.

12. The very long instruction word machine of claim 11, wherein the at least one processing element is configured to:
receive the at least one data communication from the one or more processing elements; and
transmit one or more signals indicating that the at least one data communication was served to the at least one processing element.

13. The very long instruction word machine of claim 9, wherein:
one or more processing elements that provide data in connection with processing the instruction are each configured to add at least one signal to a first aggregation of signals, the first count being based on the first aggregation of signals; and
one or more processing elements that obtain data in connection with processing the instruction are each configured to add at least one signal to a second aggregation of signals, the second count being based on the second aggregation of signals.

14. A method comprising:
compiling a program to generate instructions for processing by a plurality of processing elements of a very long instruction word machine; and
during the compiling, populating fields of the instructions, the populating comprising:
populating a first field that directs a processing element to communicate a first type of signal to an instruction controller of the very long instruction word machine in connection with providing data to one or more other processing elements to process a respective instruction; and
populating a second field that directs the processing element to communicate a second type of signal to the instruction controller in connection with receiving data from one or more of the other processing elements to process the respective instruction.

15. The method of claim 14, wherein the first field drives communication of the first type of signal based on a third type of signal being set in a data storage device of the very long instruction word machine, the third type of signal indicating that the processing element is configured to provide data to a remote processing element in connection with processing the respective instruction.

16. The method of claim 14, wherein the second field drives communication of the second type of signal based on a fourth type of signal being set in a data storage device of the very long instruction word machine, the fourth type of signal indicating that the processing element received data from a remote processing element in connection with processing the respective instruction.

17. The method of claim 14, wherein populating the fields of the instructions further includes populating a third field that identifies an instruction group of the respective instruction, the instruction group enabling the instruction controller to determine whether the instructions are dependent on the respective instruction and control dispatch of the instructions based on whether the instructions are dependent on the respective instruction.

18. The method of claim 17, wherein populating the fields of the instructions further includes populating a fourth field that indicates a priority of the instruction group in relation to additional instruction groups, the priority enabling the instruction controller to determine an order of dispatch priority for the instructions and dispatch the instructions based on the order of dispatch priority.

19. The method of claim 14, wherein populating the fields of the instructions further includes populating a third field that indicates a number of instruction cycles for which one or more processing elements are occupied with processing statically scheduled instructions, the number of instruction cycles enabling the processing element to delay providing the data to the one or more processing elements until the one or more processing elements complete processing the statically scheduled instructions.

20. The method of claim 14, wherein populating the fields of the instructions further includes populating operation fields of the instructions with operations for execution by execution units of the plurality of processing elements to perform the operations on different data.
